(19) United States
(12) Patent Application Publication
(10) Pub. No.: US 2006/0060653 A1
(43) Pub. Date: Mar. 23, 2006

(54) Scanner system and method for simultaneously acquiring data images from multiple object planes

(76) Inventors: Carl Wittenberg, Water Mill, NY (US); Pierre Craen, Lyon (FR)

Correspondence Address: Fay Kaplun & Marcin, LLP, Suite 702, 150 Broadway, New York, NY, 10038, US

(21) Appl. No.: 10/947,751

(22) Filed: Sep. 23, 2004

(51) Int. Cl. G06K 7/10

(52) U.S. Cl. 235/462.01

(57) ABSTRACT

Described is a scanner system and method for imaging an object (e.g., a data symbol, a bar code) which includes an illumination system, a chromatically aberrant lens system and an imaging sensor. The illumination system generates light of first and second wavelengths. The lens system has a first focal distance for the first wavelength light and a second focal distance for the second wavelength light. The sensor receives, via the lens system, light reflected from an object to be imaged. The sensor generates an image of the object by assembling first wavelength light focused thereon when a distance of the object from the lens system is the first focal distance and second wavelength light focused thereon when the distance of the object from the lens system is the second focal distance.

### BACKGROUND INFORMATION

Camera-based scanners are well established tools for bar code and symbol data entry in retailing and other industries. For example, a camera-based scanner may be used to read universal product code (“UPC”) bar codes and reduced space symbology (“RSS”) bar codes. Camera-based scanners may also be used to read non-UPC bar codes such as Code 3, Code 128, and two-dimensional bar codes.

Conventional camera-based scanners generally have a limited depth-of-field capable of acquiring a focused image at a single fixed distance. An image scanner capable of focusing at more than one distance would be advantageous to improve the ease of reading data symbols and decrease the time required to read each data symbol.

### SUMMARY

The present invention relates to a scanner system and method for imaging an object (e.g., a data symbol, a bar code) which includes an illumination system, a chromatically aberrant lens system and an imaging sensor. The illumination system generates light of first and second wavelengths. The lens system has a first focal distance for the first wavelength light and a second focal distance for the second wavelength light. The sensor receives, via the lens system, light reflected from an object to be imaged. The sensor generates an image of the object by assembling first wavelength light focused thereon when a distance of the object from the lens system is the first focal distance and second wavelength light focused thereon when the distance of the object from the lens system is the second focal distance.

### BRIEF DESCRIPTION OF THE DRAWINGS

FIG. 1 shows an exemplary embodiment of one-dimensional bar code;

FIG. 2 shows an exemplary embodiment of a two-dimensional bar code;

FIG. 3 shows schematically an imaging scanner system according to the present invention;

FIG. 4A shows an exemplary embodiment of an imaging sensor and a lens system according to the present invention;

FIG. 4B shows an exemplary embodiment of a imaging sensor and a lens system according to the present invention;

FIG. 5 shows an exemplary embodiment of an color array according to the present invention;

FIG. 6A shows a cross-sectional view of an exemplary embodiment of an imaging scanner according to the present invention;

FIG. 6B shows another cross-sectional view of an exemplary embodiment of an imaging scanner according to the present invention; and

FIG. 7 shows a method for simultaneously acquiring images in multiple object planes according to the present invention.

### DETAILED DESCRIPTION

The present invention is directed to a camera-based scanner (e.g., imager-chip-based scanner) which is capable of reading symbols or encoded data and, in particular, a imaging scanner capable of focusing at two or more distances simultaneously. The present invention may be useful for reading one-dimensional and two-dimensional bar codes.

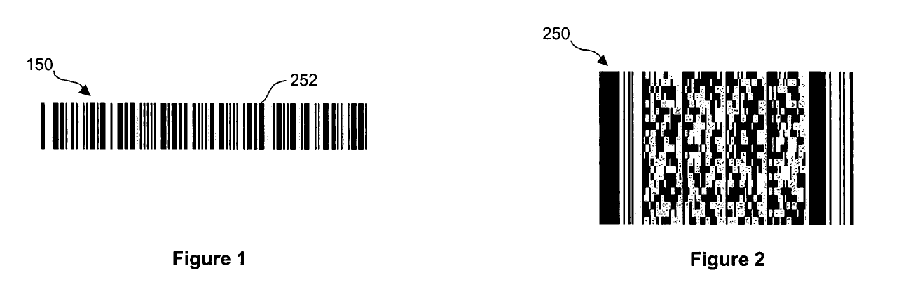

FIGS. 1 and 2 show two exemplary embodiments of encoded data (e.g., data symbols). In particular, FIG. 1 shows a one-dimensional bar code 150 (e.g., optical code) which includes a single row of parallel bars 152 containing encoded data (e.g., information). Generally, all the data contained in the one-dimensional bar code 150 is encoded in the horizontal width. As one or ordinary skill in the art would understand, increasing the data content of the one-dimensional bar code 150 may be achieved by increasing the width of the bar code 150 (e.g., adding one or more parallel bars 152).

FIG. 2 shows an exemplary embodiment of a two-dimensional bar code 250 (e.g., a PDF 417 type two-dimensional bar code). Data encoded in the two-dimensional bar code 250 is in both the horizontal and vertical dimensions. As more data is encoded, the size of the bar code 250 may be increased in both the horizontal and vertical directions, thus maintaining a manageable shape for ease of scanning. As one of ordinary skill in the art will understand, two-dimensional bar codes (e.g., the bar code 250) differ from one-dimensional or linear bar codes (e.g., the bar code 150), in that they have the ability for higher data content, small size, data efficiency and error correction capability.

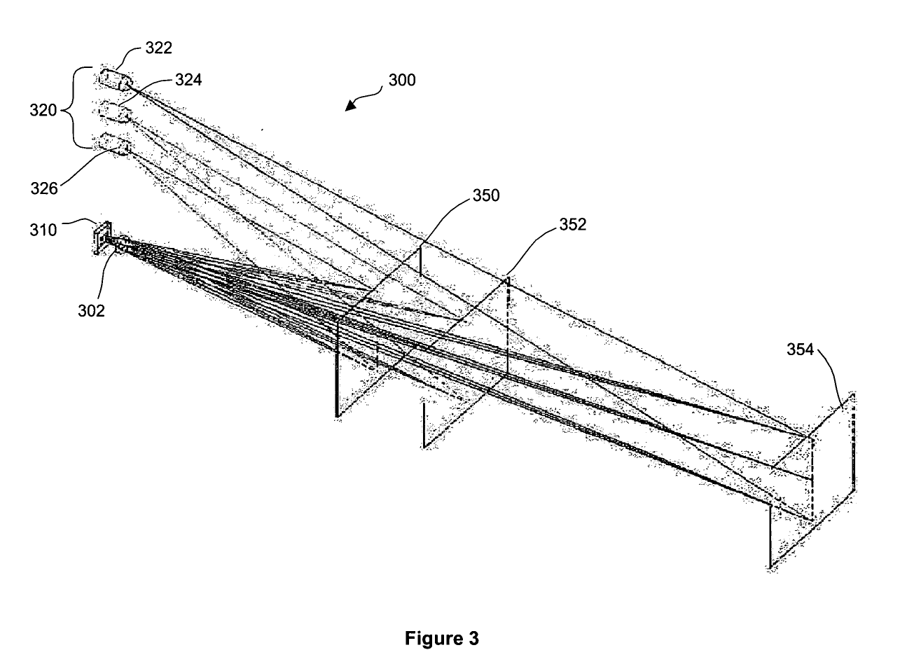

FIG. 3 shows a schematic of an exemplary imaging scanner system 300 according to the present invention. The system 300 includes a lens system 302. The lens system 302 is preferably a high chromatic aberration (e.g., chromatically aberrant) lens system. Thus, as one of ordinary skill in the art will understand, the effective focal length of the lens system 302 may be significantly different at different wavelengths. For example, the lens system 302 may include a single lens having a first focal distance for a first wavelength of light and a second focal distance for a second wavelength of light. In other exemplary embodiments of the present invention, the lens system 302 may include a plurality of lenses (e.g., three lenses) optimized to provide chromatic aberration correction in a plurality of chromatically separated regions (e.g., three regions).

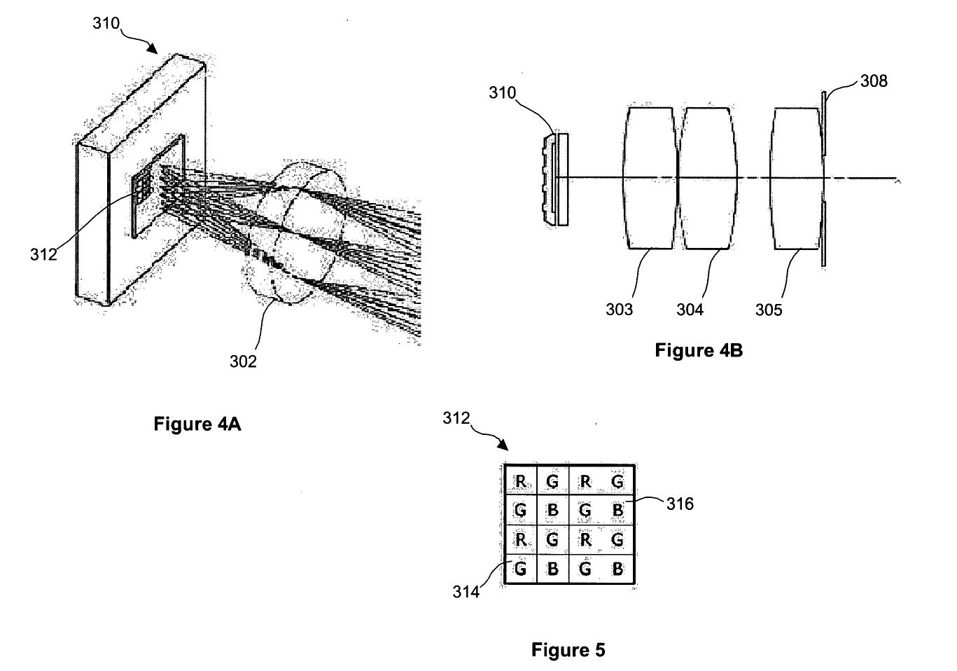

Shown also in FIG. 4A, the lens system 302 may be a single convex-convex lens. In the exemplary embodiment, the lens system 302 is a convex-convex lens with symmetrical 7.59 mm radii surfaces and a 2.54 mm center thickness. However in another embodiment according to the present invention shown in FIG. 4B, the lens system 302 includes a plurality of lenses. For example, the lens system 302 may include a first lens 303, a second lens 304, and a third lens 305. In the exemplary embodiments, the first, second, and third lenses 303/304/305 may be a 6×18 mm lens, a 6×12 mm lens, and a 6×18 mm lens, respectively. Also shown in FIG. 4B, the lens system 302 may include an aperture 308. The aperture 308 may be, for example, a 2 mm diameter aperture.

The lenses of the lens system 302 may be manufactured of a material with a low Abbe number. As one of ordinary skill in the art will understand, the Abbe number (V) of a material (e.g., an optical medium) is a measure of the material's dispersion or variation of refractive index with wavelength. Low dispersion materials generally have high values of V. The Abbe number is also directly proportional to the chromatic quality of a lens. In the exemplary embodiment, the lens system 302 may be manufactured of an extra dense flint glass (e.g., SF5 glass) with an Abbe number of less than thirty-five (35), e.g., twenty (20).

The system 300 includes an imaging sensor 310. The imaging sensor may be, for example, a solid-state imaging array. In the exemplary embodiment, the imaging sensor 310 is positioned approximately 5.3096 mm from the lens system 302. The imaging sensor 310 may be a color sensor capable of acquiring images in multiple object planes simultaneously. In the exemplary embodiment, the imaging sensor 310 is a KAC-1310 RGB CMOS Imaging sensor available from Kodak Corporation. However, any similarly capable imaging sensor 310 may be used.

The imaging sensor 310 may include a color filter 312. The color filter 312 may be, for example, a Bayer RGB color filter including an array of red (R), green (G), and blue (B) filters (e.g., 314, 316) covering individual pixels. An exemplary embodiment of a color filter 312 (e.g., a Bayer RGB color filter) is shown schematically in FIG. 5. As one of ordinary skill in the art will understand, the color filter 312 shown in FIG. 5 represents only a portion of a complete color filter 312. In the exemplary embodiment, the color filter 312 may include, for example, a 1280×1024 array of square active imaging pixels with a pitch of approximately six (6) microns. Alternatively, the imaging sensor 310 may be linear array of pixels with a pattern of red, green, and blue filters. As one of ordinary skill in the art will understand, such a linear (i.e., one-dimensional) array may favor a lower cost system in exchange for giving up the ability to read two dimensional bar code symbols (e.g., bar code 250).

As shown in FIG. 3, the system 300 according to the present invention includes an illumination system 320. As one of ordinary skill in the art will understand, the illumination system 320 may provide light on any number of object planes (e.g., 350, 352, 354) to allow the imaging sensor 310 to simultaneously acquire images on the object planes 350/352/354. The illumination system 320 may provide light at colors that correspond to peak response wavelengths of the imaging sensor 310. Illumination with sharp bands at these wavelengths is preferable to produce the most distinct image separation. However, white light may also be used.

The illumination system 320 preferably includes at least two light sources. As one of ordinary skill in the art will understand, any number of light sources may be used depending on the number of focal lengths desired. In the exemplary embodiment, the illumination system includes three light sources, e.g., 322, 324, and 326. Each light source 322/324/326 and may provide light at a different wavelength than the other light sources. For example, the light source 322 may provide red light with a wavelength of approximately 635 nm, the light source 324 may provide green light with a wavelength of approximately 530 nm, and the light source 326 may provide blue light with a wavelength of approximately 470 nm.

The system 300 may be designed to acquire images (e.g., read a data symbol) at any distance or distances from lens system 302. For example, the lens system 302 may have three different focal lengths corresponding to the different wavelengths of light provided by each light source 322/324/326. Light from each light source 322/324/326 may be reflected off object planes (e.g., 350, 352, 354) situated at distances corresponding approximately to the designed focal lengths. The reflected light may then be received by the imaging sensor 310 via the lens system 302.

In the exemplary embodiment, the system 300 is optimized to acquire sharp images at 155 mm (e.g., object plane 350) using the 470 nm blue light, at 257 mm (e.g., object plane 352) with the 530 nm green light, and at 829 mm (e.g., object plane 354) with the 635 nm red light. Therefore, as a data symbol is moved between three different distances from the lens system 302, its image may be focused in the different object planes 350/352/354 (i.e., at the predetermined distances). Likewise, the lens system 302 may be moved (i.e., rather than the data symbol) between three different distances from the data symbol and the image of the data symbol focused in the different object planes 350/352/354. The different colors (i.e., wavelengths) of the light received by the imaging sensor 310 may be separated by the color filter 312 of the imaging sensor 310 to generate an image of the data symbol.

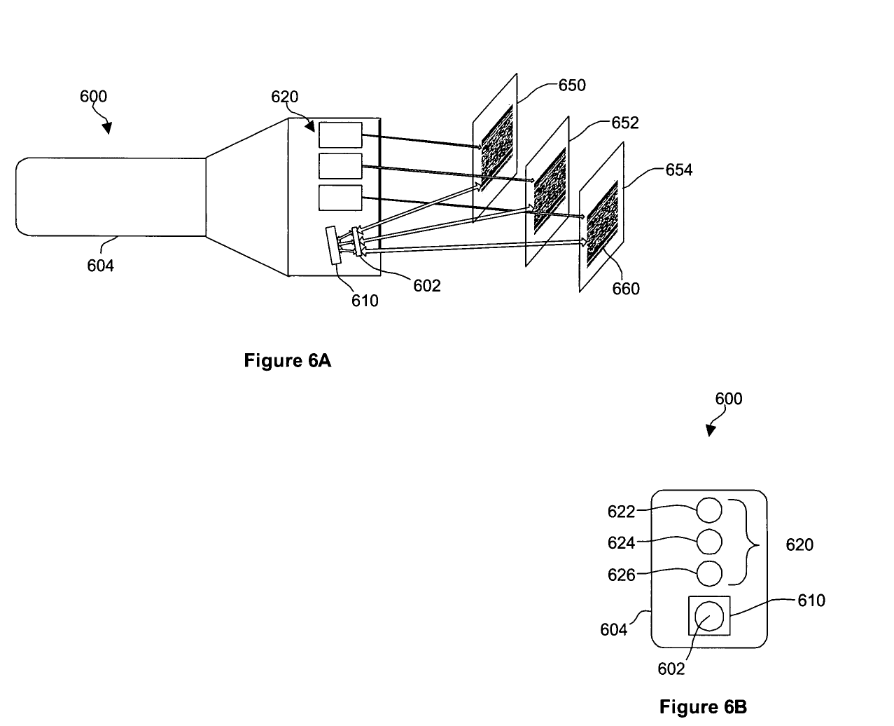

FIGS. 6A and 6B show an exemplary embodiment of an imaging scanner 600 according the present invention. The imaging scanner 600 includes a housing 604. The housing 604 may, for example, be adapted for handheld (e.g., portable or mobile) or stationary (e.g., surface mounted) use. Situated within the housing 604, the imaging scanner 600 may include an imaging sensor 610 and a lens system 602. The imaging scanner 600 may also include an illumination system 620. The illumination system 620 may include three light sources, e.g., a first light source 622, a second light source 624, and a third light source 626. The imaging scanner may also include a processor (not shown).

The imaging scanner 600 may be used to read or decode a data symbol, e.g. a bar code 660. For example, the illumination system 620 may direct a portion of light at a first distance, a portion of light at a second distance, and a portion of light at a third distance. In the present example, the distances correspond to a first object plane 650, a second object plane 652, and third object plane 654 respectively. The bar code 660, or any other data symbol known to those in the art, may lie in one or more of the object planes 650/652/654. The imaging sensor 610 of the imaging scanner 600 may acquire a focused image of the bar code 660 when it is approximately within any one of the object planes 650/652/654. The imaging sensor 610 may then separate the acquired images, preferably with minimal superposition. The processor (not shown) of the imaging scanner 600 may then decode or read the image(s) of the bar code 660.

As one of ordinary skill in the art will understand, a conventional imaging scanner may have only one focal length, i.e. only one optimal distance at which a sharp image of a data symbol may be acquired. The present invention includes at least two, and preferably three, focal lengths at which focused images may be acquired simultaneously. Therefore, the imaging scanner 600 according the present invention need not be positioned at a single optimal distance to scan a data symbol. The imaging scanner 600 according to the present invention may provide for quick and accurate scanning.

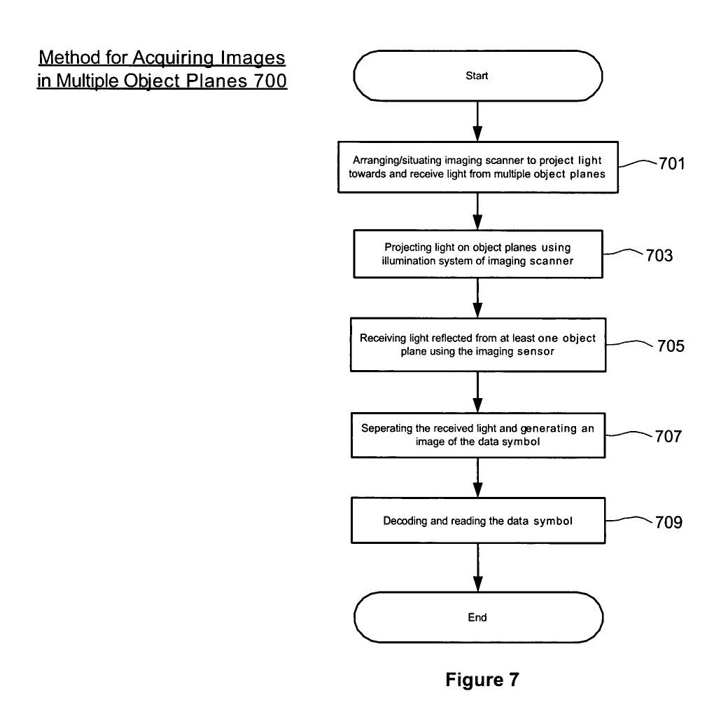

FIG. 7 shows an exemplary method 700 according to the present invention for simultaneously acquiring images in multiple object planes. The method 700 may be used, for example, to scan (e.g., read) a data symbol (e.g., bar code). The exemplary method 700 described below and shown in FIG. 7 may be applicable and utilized with a plurality of exemplary embodiments of the system 300 and imagining scanner 600 described above and shown in FIGS. 3, 6A and 6B. The exemplary method 700 will be described with reference to the imaging scanner 600.

In step 701, the imaging scanner 600 is arranged to project light towards and receive light from a plurality of object planes (e.g., object planes 650/652/654). For example, the imaging scanner 600 may be directed towards one or more data symbols (e.g., bar code 660). The imaging scanner 600 may be approximately situated at one of any number of known distances (e.g., focal lengths) from the bar code(s) 660. However, as discussed above the imaging scanner 600 according to the present invention may have multiple design focal lengths corresponding to distances for optimal image scanner performance. Therefore, precise situation of the imaging scanner 600 with reference to the data symbol(s) may not be necessary.

In step 703, light is projected on at least one of the object planes 650/62/654 using the illumination system 620. As described above, the illumination system 620 preferably includes at least two light sources. However, the illumination system 620 may include additional light sources if additional focal lengths are desired. For example, the illumination system 620 may project multiple wavelengths of light from a first light source 622, a second light source 624, and a third light source 626. Each light source may provide light at a color that corresponds to a peak response wavelength of the imaging sensor 610. Illumination with sharp bands at these wavelengths is preferable to produce the most distinct image separation. For example, the light source 622 may provide red light with a wavelength of approximately 635 nm, the light source 624 may provide green light with a wavelength of approximately 530 nm, and the light source 626 may provide blue light with a wavelength of approximately 470 nm.

In step 705, light reflected from at least one object plane is received by the imaging sensor 610 via the lens system 602. For example, light originating from the light sources 622, 624, and 626 may be reflected off one or more of the object planes 650,652, and 654, respectively. A bar code 660 may lie in one or more of the object planes 650/652/654. The reflected light at differing wavelengths may be received by the imaging sensor 610 via the lens system 602.

In a step 707, a color filter (e.g., color filter 312) of the imaging sensor 610 separates the reflected light having originated from one or more of the light sources 622/624/626. The imaging sensor 610 then generates an image of the data symbol (e.g., bar code 660). For example, the imaging sensor 610 may generate a digital and/or analog output representing each pixel in the imaging sensor 610.

In step 709, a processor of the imaging scanner 600 may decode or read the image(s) of the date symbol. For example, the processor may decode data in the bar code 660 using the images obtained from the object planes 650/652/654.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. A scanner system for imaging an object, comprising:
an illumination system generating light of first and second wavelengths;
a chromatically aberrant lens system having a first focal distance for the first wavelength light and a second focal distance for the second wavelength light; and
an imaging sensor receiving, via the lens system, light reflected from an object to be imaged, the sensor generating an image of the object by assembling first wavelength light focused thereon when a distance of the object from the lens system is the first focal distance and second wavelength light focused thereon when the distance of the object from the lens system is the second focal distance.

2. The scanner according to claim 1, wherein the illumination system generates light of a third wavelength, the lens system having a third focal distance for the third wavelength, the sensor generating the image of the object by further assembling third wavelength light focused thereon when a distance of the object from the lens system is the third focal distance.

3. The scanner according to claim 2, wherein the first wavelength is about 635 nm, the second wavelength is about 530 nm, and the third wavelength is about 470 nm.

4. The scanner according to claim 2, wherein the first focal distance is about 155 mm, the second focal distance is about 257 mm, and the third focal distance is about 829 mm.

5. The scanner according to claim 1, wherein the lens system includes a single convex-convex lens.

6. The scanner according to claim 1, wherein the lens system includes a plurality of lenses, at least one of the plurality of lenses being a convex-convex lens.

7. The scanner according to claim 1, wherein the object is one of a data symbol, a one-dimensional bar code, and a two-dimensional bar code.

8. The scanner according to claim 1, wherein the lens system is at least partially composed of an extra-flint glass.

9. The scanner according to claim 1, wherein the imaging sensor includes a color filter array of a plurality of color filters.

10. The scanner according to claim 1, wherein the imaging sensor is a solid-state imaging array.

11. The scanner according to claim 1, wherein the illumination system includes a first light source generating light of the first wavelength and a second light source generating light of the second wavelength.

12. The scanner according to claim 1, wherein the scanner is a bar code scanner.

13. The scanner according to claim 1, wherein the scanner is a portable bar code scanner.

14. The scanner according to claim 2, wherein the illumination system includes a first light source generating light of the first wavelength, a second light source generating light of the second wavelength and a third light source generating light of the third wavelength.

15. The scanner according to claim 1, further comprising:
a processor processing the image to generate data corresponding to the object.

16. A method for imaging an object, comprising the steps of:
(a) generating light of first and second wavelengths using an illumination system;
(b) with an imaging sensor receiving, via a chromatically aberrant lens system, light reflected from an object to be imaged, the lens system having a first focal distance for the first wavelength light and a second focal distance for the second wavelength light
(c) generating, using the sensor, an image of the object by assembling first wavelength light focused thereon when a distance of the object from the lens system is the first focal distance and second wavelength light focused thereon when the distance of the object from the lens system is the second focal distance.

17. The method according to claim 16, wherein the step (a) further includes the substep of generating, using the illumination system, light of a third wavelength, wherein the step (b) further includes a substep of generating, using the sensor, the image of the object by further assembling third wavelength light focused thereon when a distance of the object from the lens system is the third focal distance, the lens system having a third focal distance for the third wavelength.

18. The method according to claim 16, wherein the lens system includes at least one convex-convex lens.

19. The method according to claim 16, wherein the object is one of a data symbol, a one-dimensional bar code, and a two-dimensional bar code.

20. The method according to claim 16, wherein the scanner is a bar code scanner.

21. The method according to claim 16, further comprising:
processing the image to generate data corresponding to the object.
